(19) United States
(12) Patent Application Publication
(10) Pub. No.: US 2004/0192136 A1
(43) Pub. Date: Sep. 30, 2004

(54) Liquid absorbent wiping products made from airlaid webs

(75) Inventors: Robert Irving Gusky, Appleton, WI (US); Jeffrey J. Johnson, Neenah, WI (US); Juha P. Kemppinen, Evans, GA (US); Frederick J. Lang, Neenah, WI (US); Kambiz Bayat Makoui, Neenah, WI (US); Kim Gerald Schick, Menasha, WI (US); Richard L. Underhill, Neenah, WI (US); Kevin Joseph Vogt, Neenah, WI (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 10/396,743

(22) Filed: Mar. 25, 2003

(51) Int. Cl. B32B 5/02

(52) U.S. Cl. 442/264

(57) ABSTRACT

Airlaid paper wiping products are disclosed having improved wipe dry characteristics in conjunction with softness properties. The wiping products are formed from an airlaid nonwoven web containing pulp fibers. The pulp fibers, in one embodiment, may include low coarseness softwood fibers, such as low coarseness softwood fibers. A bonding material may be applied to one or both sides of the nonwoven web. The wiping product can be used as a paper towel, industrial wiper, and the like.

### BACKGROUND OF THE INVENTION

In the manufacture of a number of paper products, such as tissues, towels, napkins, wipers and the like, a wide variety of product characteristics must be given attention in order to provide a final product with the appropriate blend of attributes suitable for the intended purpose of the product. Among these various attributes, improving softness, strength, absorbency, bulk and stretch have always been major objectives, particularly for products in the consumer markets. For example, consumers desire paper towels that are moldable during use, that absorb large spills, and that do not tear when wet. In addition, the manufacturer desires a firm paper product that has a low roll weight and a large diameter.

In the past, many attempts have been made to enhance and increase certain physical properties of paper wiping products and other similar articles. Unfortunately, however, when steps are usually taken to increase one property of a wiping product, other characteristics of the product may be adversely affected. For instance, in pulp fiber based wiping products, softness can be increased by decreasing or reducing interfiber bonding within the paper web. Inhibiting or reducing fiber bonding, however, may adversely affect the strength of the product.

Traditionally, many paper products have been made using a wet-pressing process in which a significant amount of water is removed from a wet-laid web by pressing or squeezing water from the web prior to final drying. In particular, while supported by an absorbent papermaking felt, the web is squeezed between the felt and the surface of a rotating heated cylinder, such as a Yankee dryer, using a pressure roll as the web is transferred to the surface of the Yankee dryer. The dried web is then removed from the surface of the dryer with a doctor blade, which is known as creping. Creping serves to partially debond the dried web by breaking many of the bonds previously formed during the web-pressing stages of the process. The web may be creped dry or wet. Creping can greatly improve the feel of the web, but at the expense of a loss in strength.

Wet-laid webs are disclosed, for instance, in U.S. Pat. No. 3,879,257 to Gentile et al., which is incorporated herein by reference. The fibrous webs disclosed in Gentile et al. are formed from an aqueous slurry of fibers. A bonding material, such as a latex elastomeric composition, is applied to at least one surface of the web in a spaced-apart pattern. The bonding material provides strength to the web and abrasion resistance to the surface.

Once the bonding material is applied to one side of the web, the web can be brought into contact with a creping surface. The web adheres to the creping surface according to the pattern by which the bonding material was applied. The web is then creped from the creping surface with a doctor blade.

In one alternative embodiment disclosed in Gentile et al., both sides of the paper web are printed with the bonding material and both sides are thereafter creped.

The processes disclosed in Gentile et al. have provided great advancements in the art of making disposable wiping products. In fact, many paper products made according to the processes disclosed in Gentile et al. have displayed properties superior to paper products made according to other processes, such as webs made according to an airlaying process.

Conventional airlaying processes typically include one or more forming chambers that are placed over a moving foraminous surface, such as a forming screen. Fibrous materials and/or particulate materials are introduced into the forming chamber and a vacuum source is employed to draw an airstream through the forming surface. The air stream deposits the fibers and/or particulate material onto the moving forming surface. Once the fibers are deposited onto the forming surface, an airlaid web is formed.

In the past, problems have been experienced in producing airlaid wiping products that have absorbent properties comparable to wet-laid webs, such as webs made according to the processes disclosed in Gentile et al. As such, a need currently exists for a process for producing airlaid webs that have improved absorbent properties. A need also exists for a process that not only improves the absorbent properties of an airlaid web, but also produces a web with good softness and strength properties.

### DEFINITIONS

Geometric Mean Modulus:

The geometric mean modulus (gmm) is equal to the square root of the product of the dry machine direction modulus of a sample multiplied by the dry cross machine direction modulus of the sample. The modulus of a sample is determined by the slope of a stress-strain curve. The geometric mean modulus can be reported in kilometers (km).

To determine the geometric mean modulus of a sample, a tensile tester is utilized, such as a Sintech tensile tester, manufactured by Sintech Inc. of Research Triangle Park, N.C. In particular, under TAPPI test conditions, a sample of the paper product is placed into the jaws of the tensile tester. The jaws are generally a pair of rectangular pieces. The sample must be large enough to fit between the span of the jaws. Typically, the sample is about 3 inches wide and at least 4 inches long, as the span of the jaws of the Sintech tensile tester is 4 inches. After the sample is placed into the jaws, one piece of the jaw moves outward and the second piece is stationary. The piece of the jaw that moves has a strain gauge attached to it, which measures the strain placed on the sample. The jaw moves at a selected rate, such as 10 inches per minute.

The paper product is tested in the machine direction and in the cross machine direction. Generally, at least 5 to 10 samples are tested in both directions and an average is taken of all the sample values.

The Sintech tensile tester produces a stress-strain curve for each sample. The stress is on the Y-axis, while the strain is on the X-axis. The tensile tester is programmed such that it calculates the slope between the load points of 70 grams and 157 grams. The slope is expressed as kilograms per 76.2 millimeters of sample width. The slope divided by the product of basis weight (expressed in grams per square meter) times 0.0762 is the modulus (expressed in kilometers) for the direction (MD or CD) of the sample being tested. Once the modulus in the machine direction and the modulus in the cross machine direction are determined, the geometric mean modulus can then be calculated according to the equation stated above.

Low Coarseness Softwood Fibers:

As used herein, low coarseness softwood fibers are fibers that have a Pulp Coarseness Index of less than 18 mg/100 m. For example, relatively low coarseness softwood fibers include RAUMA BIOBRIGHT TR fibers, which have a Pulp Coarseness Index of about 13.9 mg/100 m. Many other different varieties of softwood fibers may have a Pulp Coarseness Index of much greater than 18 mg/100 m. For example, some forms of southern softwood kraft fibers have a Pulp Coarseness Index of greater than about 22 mg/100 m.

The Pulp Coarseness Index for any species of fiber or any fiber furnish is the weight per unit length of fiber (e.g. milligrams per 100 meters) and is defined as follows:

$$Pulp Coarseness Index = \frac{100}{( \frac{F}{G} ) ( L )}$$

wherein (F/G) equals millions of fibers per gram of fiber, and (L) equals the numerical average length of the fibers in millimeters.

Measuring the Pulp Coarseness Index for a given fiber species can yield different values depending upon the measurement method. As used herein, the Pulp Coarseness Index of fibers was measured using a Fiber Quality Analyzer marketed by OpTest Equipment, Inc. of Ontario, Canada. The above instrument or an equivalent thereof can be used for measuring the Pulp Coarseness Index for purposes herein.

Wipe Dry:

In general, wipe dry is a test that measures the amount of a spill that can be wiped dry from a surface by a paper product. Wipe dry is reported as a percentage.

To determine the wipe dry of a product, an abrasion tester is used, such as Number AG-8100 Abrasion Tester with a plastic test surface manufactured by BYK Gardner. During the test, the abrasion tester is operated to provide reciprocating linear motion at 37.0±1 cycles per minute with a constant speed over a 10 inch travel of 12.3 inches per second. In conducting the test, under TAPPI test conditions, a sample of a paper product is cut in the machine direction to have a size of 5 inches in length by 2 inches in width. The sample is attached to a test block by applying tape to the ends of the sample. The test block is wiped dry prior to attaching and centering the sample on the block. The contact area of the sample is 2.00 inches by 3.25 inches. Based on the above contact area, a 173 gram test block weight is equal to a wiping pressure of 0.06 psi (equivalent water column height of 41 mm).

After the sample is attached to the test block, the sample and the test block are weighed to the nearest 0.001 grams. The abrasion tester is set for 2 cycles and the clear cycle counter is set to zero. 1.000 grams of distilled water is applied to a crosshair located on a test surface of the abrasion tester. The water must be applied to the test surface so that all of the water is within the contact area of the test block.

The test block and sample are placed in a test block holder of the abrasion tester. The test block holder is rotated to horizontal orientation and gently lowered against the water on the test surface.

After 2 seconds, the “run” button on the abrasion tester is pressed and the sample travels through 2 cycles. When the cycles are completed and the test block holder stops, the sample and test block are removed from the abrasion tester. The test block and wet sample are then weighed to the nearest 0.001 grams. The percentage of water wiped dry from the test surface is then calculated according to the following formula:

$$\begin{matrix}\% Water \\ Wiped Dry\end{matrix} = \frac{( wt . of block + wet sample ) - ( wt . of block + dry sample )}{( wt . of water spill )}$$

### SUMMARY OF THE INVENTION

In general, the present invention is directed to a wiping product. The wiping product can be, for instance, a tissue product that can serve as a paper towel, an industrial wiper, or the like. The wiping product is made from an airlaid fibrous web comprising pulp fibers. In one embodiment, for instance, the web can be made from low coarseness softwood fibers. The low coarseness softwood fibers can have a Pulp Coarseness Index of less than about 18 mg/100 m and, in one embodiment, can have a Pulp Coarseness Index of less than about 16 mg/100 m.

In accordance with the present invention, the wiping product has a wipe dry of at least about 94% in combination with a geometric mean modulus of less than about 2.25 km (kilometer). For example, in other embodiments, the wiping product can have a wipe dry of greater than about 94.5%, and greater than about 95%. Further, the geometric mean modulus can be less than about 2.10 km. The wiping product can also have a density of less than about 0.10 g/cc and can have a basis weight of from about 30 gsm to about 90 gsm, such as from about 50 gsm to about 80 gsm.

In one embodiment, a bonding material can be applied to one side or to both sides of the fibrous web. The bonding material can be, for instance, a latex, such as an ethylene vinyl acetate copolymer.

The bonding material can be applied so as to cover at least 70% of the surface area of each side of the web, and, in one embodiment, can cover at least about 90% of the surface area of each side of the web. When applied, the bonding material can have a solids content of greater than about 12%, such as greater than about 15%. The total add-on of the bonding material may be less than about 15%, such as less than about 13%.

Other features and aspects of the present invention are discussed in greater detail below.

### BRIEF DESCRIPTION OF THE DRAWINGS

A full and enabling disclosure of the present invention, including the best mode thereof to one of ordinary skill in the art, is set forth more particularly in the remainder of the specification, including reference to the accompanying figures in which:

FIG. 1 is a simplified cross sectional view of one embodiment of an airlaying apparatus that can be used in the process of the present invention;

FIG. 2 is a simplified diagramatical view of one embodiment of a system for forming airlaid non-woven webs in accordance with the present invention; and

FIG. 3 is a graphical representation of the results obtained in the example described below.

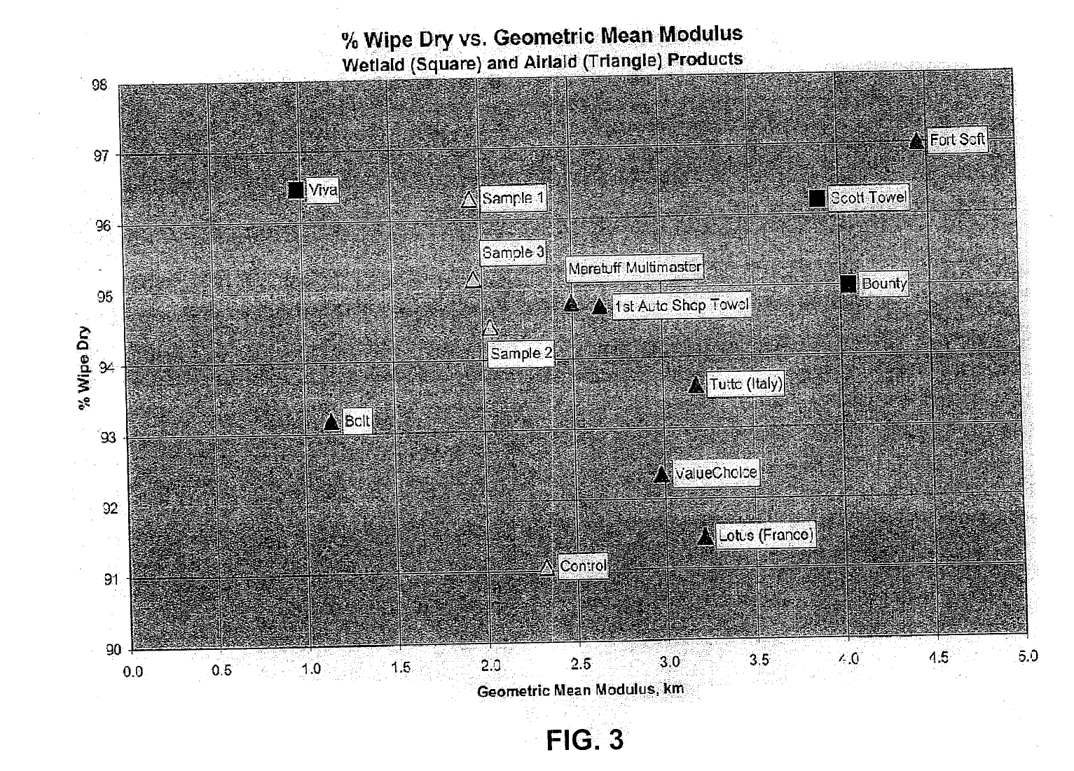

Repeated use of reference characters in the present specification and drawings is intended to represent the same or analagous features or elements of the present invention.

### DETAILED DESCRIPTION OF THE INVENTION

It is to be understood by one of ordinary skill in the art that the present discussion is a description of exemplary embodiments only, and is not intended to limit the broader aspects of the present invention, as may be embodied in the exemplary construction.

In general, the present invention is directed to highly absorbent airlaid webs and to various processes for producing the webs. In addition to being highly liquid absorbent, these airlaid webs are also very soft having cloth-like properties. In fact, it is believed that airlaid webs made according to the present invention possess a combination of properties and characteristics not before seen by any commercial airlaid wiping products.

Wipe dry is an important requirement for many paper wiping products and is a measurement of the amount of a spill that can be wiped dry from a surface with the product. Historically, airlaid webs and airlaid towels in particular have not generally demonstrated wipe dry properties similar to those of comparative wet-laid products. Airlaid webs made according to the present invention, however, have demonstrated a wipe dry of greater than about 94%, particularly greater than 94.5%, and greater than about 95%. In one embodiment, for instance, it is believed that an airlaid web can be made having a wipe dry of from about 96% to about 98%.

Further, airlaid webs made according to the present invention can have the above wipe dry characteristics while remaining soft and having a cloth-like feel. Specifically, the airlaid webs can also have a geometric mean modulus, which generally measures the stiffness of the web, of less than about 2.25 km and particularly less than about 2.10 km. In one embodiment, for example, the airlaid web can have a geometric mean modulus of less than about 2.00 km.

Of particular advantage, airlaid webs made according to the present invention can have the above characteristics and properties without having to greatly increase the amount of pulp fibers that are used to make the webs. For example, the airlaid webs can have a density of from about 0.05 g/cc to about 0.5 g/cc. In many embodiments, however, the density of the airlaid webs can be less than about 0.15 g/cc, such as less than about 0.10 g/cc. For example, in one embodiment, the airlaid webs can have a density of less than about 0.09 g/cc.

The basis weight of the airlaid products made according to the present invention can vary depending on the particular application and the desired use. For most embodiments, for instance, the basis weight of the airlaid webs can be from about 35 gsm to about 120 gsm, such as from about 50 gsm to about 80 gsm.

In general, the wiping products of the present invention are produced by first forming an airlaid nonwoven web containing cellulosic fibers. The formed airlaid web is then compacted to a desired density and treated with a bonding material. Specifically, a bonding material is sprayed onto the airlaid web. For most applications, for instance, the bonding material is applied to both sides of the web.

In order to form airlaid wiping products having the above described wipe dry and geometric mean modulus characteristics, the present inventors discovered that by modifying various process steps used to form the webs and by choosing particular materials to form the web in a particular combination, airlaid wiping products may be produced with the improved properties. For example, the present inventors discovered that the wipe dry characteristics of the web are improved by incorporating relatively low coarseness softwood fibers into the web. Further, the present inventors discovered that the wipe dry characteristics of the web were further improved by applying a bonding material to the web through a spray nozzle at a selected distance from the formed web, at a particular amount of pressure, at a particular solids level, and at a particular add-on rate. For instance, the present inventors discovered that the wipe dry characteristics were improved by decreasing nozzle pressure, by increasing the solids content of the bonding material, and by lowering the total add-on of the bonding material to the web in combination. Further, the above combination of factors not only improves the wipe dry characteristics of the web but also produced an airlaid web having improved geometric mean modulus characteristics at an acceptable density and basis weight.

In developing the present invention, it is believed that no single factor contributed to the results obtained. Instead, it is believed that the above multiple factors taken in combination produced the inventive results.

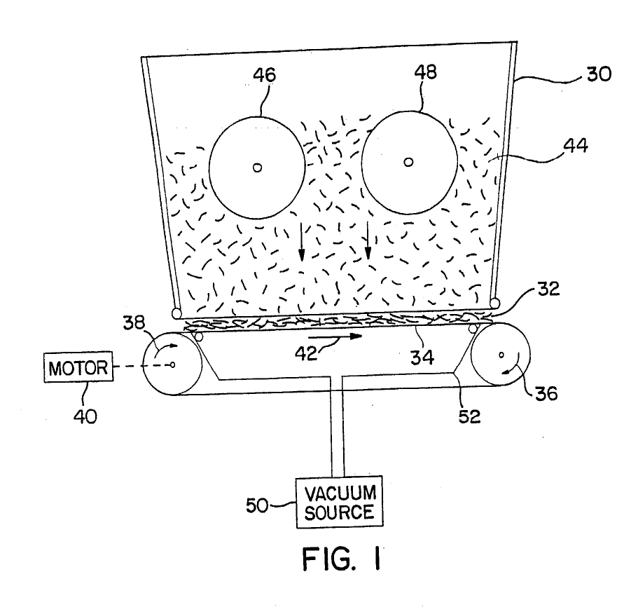

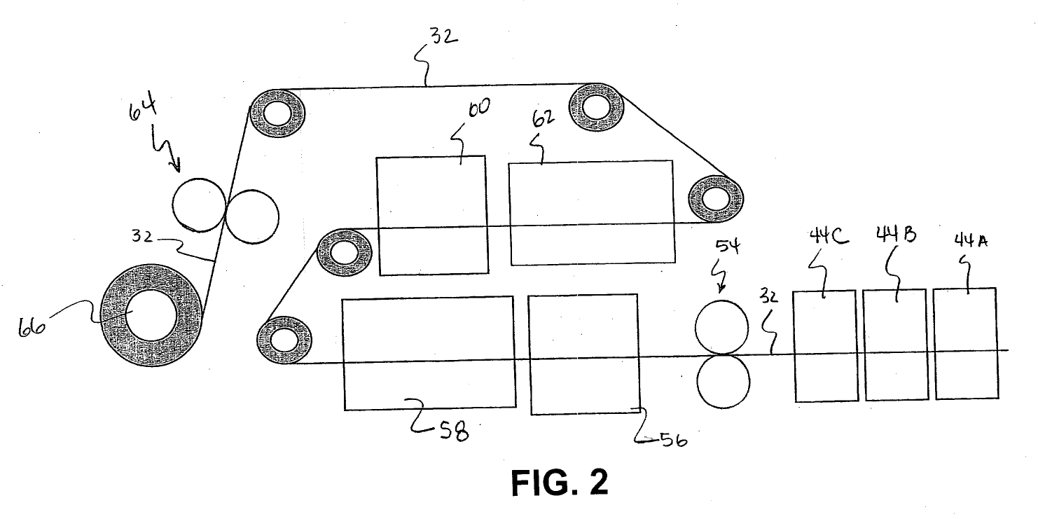

One embodiment of a process for forming airlaid webs in accordance with the present invention will now be described in detail with particular reference to FIGS. 1 and 2. It should be understood that the airlaying apparatus illustrated in FIG. 1 is provided for exemplary purposes only and that any suitable airlaying equipment may be used in the process of the present invention. Referring to FIG. 1, an airlaying forming station 30 is shown which produces an airlaid web 32 on a forming fabric or screen 34. The forming fabric 34 can be in the form of an endless belt mounted on support rollers 36 and 38. A suitable driving device, such as an electric motor 40 rotates at least one of the support rollers 38 in a direction indicated by the arrows at a selected speed. As a result, the forming fabric 34 moves in a machine direction indicated by the arrow 42.

The forming fabric 34 can be provided in other forms as desired. For example, the forming fabric can be in the form of a circular drum which can be rotated using a motor as disclosed in U.S. Pat. No. 4,666,647, U.S. Pat. No. 4,761,258, or U.S. Pat. No. 6,202,259, which are incorporated herein by reference. The forming fabric 32 can be made of various materials, such as plastic or metal.

As shown, the airlaying forming station 30 includes a forming chamber 44 having end walls and side walls. Within the forming chamber 44 are a pair of material distributors 46 and 48 which distribute fibers and/or other particles inside the forming chamber 44 across the width of the chamber. The material distributors 46 and 48 can be, for instance, rotating cylindrical distributing screens.

In the embodiment shown in FIG. 1, a single forming chamber 44 is illustrated in association with the forming fabric 34. It should be understood, however, that more than one forming chamber can be included in the system. By including multiple forming chambers, layered webs can be formed in which each layer is made from the same or different materials.

Airlaying forming stations as shown in FIG. 1 are available commercially through Dan-Webforming Int. LTD. of Aarhus, Denmark. Other suitable airlaying forming systems are also available from M & J Fibretech of Horsens, Denmark. As described above, however, any suitable airlaying forming system can be used in accordance with the present invention.

As shown in FIG. 1, below the airlaying forming station 30 is a vacuum source 50, such as a conventional blower, for creating a selected pressure differential through the forming chamber 44 to draw the fibrous material against the forming fabric 34. If desired, a blower can also be incorporated into the forming chamber 44 for assisting in blowing the fibers down on to the forming fabric 34.

In one embodiment, the vacuum source 50 is a blower connected to a vacuum box 52 which is located below the forming chamber 44 and the forming fabric 34. The vacuum source 50 creates an airflow indicated by the arrows positioned within the forming chamber 44. Various seals can be used to increase the positive air pressure between the chamber and the forming fabric surface.

During operation, typically a fiber stock is fed to one or more defibrators (not shown) and fed to the material distributors 46 and 48. The material distributors distribute the fibers evenly throughout the forming chamber 44 as shown. Positive airflow created by the vacuum source 50 and possibly an additional blower force the fibers onto the forming fabric 34 thereby forming an airlaid non-woven web 32.

The material that is deposited onto the forming fabric 34 will depend upon the particular application. The fiber material that can be used to form the airlaid web 32, for instance, can include natural fibers alone or in combination with synthetic fibers. Examples of natural fibers include wood pulp fibers, cotton fibers, wool fibers, silk fibers and the like, as well as combinations thereof. Synthetic fibers can include rayon fibers, polyolefin fibers, polyester fibers and the like, as well as combinations thereof. Polyolefin fibers include polypropylene fibers and polyethylene fibers. Synthetic fibers can be present, for instance, in an amount up to about 50% by weight, such as up to about 30% by weight of the furnish. The fibers can have various lengths, such as up to about 6 to about 8 millimeters or greater.

When wood pulp fibers are present in the airlaid web of the present invention, the pulp fibers may be in a rolled and fluffed form. As is known to those skilled in the art, fluffed fibers generally refer to fibers that have been shredded.

In one embodiment, the present inventors have found that the wipe dry properties of the resulting airlaid web are improved if low coarseness softwood fibers are incorporated into the web. Low coarseness softwood fibers include, for instance, RAUMA CELL BIOBRIGHT TR pulp obtained from UPM-Kymmene, which is made from Scandanavian softwood fibers. The above low coarseness softwood fibers have been defiberized by being processed through, for instance, a hammermill. Low coarseness softwood fibers typically have a relatively small diameter and are smaller in length than comparable fibers. The low coarseness softwood fibers can have a Pulp Coarseness Index of less than about 18 mg/100 m, such as less than about 16.5 mg/100 m. For instance, in one embodiment, the fibers may have a Pulp Coarseness Index of less than about 15 mg/100 m.

The low coarseness softwood fibers may be used alone or in combination with various other fibers in forming the airlaid web. Further, different types of low coarseness softwood fibers may be combined to form the web as well.

The pulp fibers used to form airlaid webs in accordance with the present invention may be pretreated with a debonding agent prior to incorporation into the airlaid web. Suitable debonding agents that may be used in the present invention include cationic debonding agents such as fatty dialkyl quaternary amine salts, mono fatty alkyl tertiary amine salts, primary amine salts, imidazoline quaternary salts, silicone quaternary salt and unsaturated fatty alkyl amine salts. Other suitable debonding agents are disclosed in U.S. Pat. No. 5,529,665 to Kaun which is incorporated herein by reference. In particular, Kaun discloses the use of cationic silicone compositions as debonding agents.

In one embodiment, the debonding agent used in the process is an organic quaternary ammonium chloride and particularly a silicone based amine salt of a quaternary ammonium chloride. For example, the debonding agent can be PROSOFT TQ1003 marketed by the Hercules Corporation. The debonding agent can be added to a fiber slurry in an amount of from about 1 kg per metric tonne to about 6 kg per metric tonne of fibers present within the slurry.

When forming the airlaid web 32 from different materials and fibers, the forming chamber 44 can include multiple inlets for feeding the materials to the chamber. Once in the chamber, the materials can be mixed together if desired. Alternatively, the different materials can be separated into different layers in forming the web.

Referring to FIG. 2, one embodiment of a simplified diagram of an entire web forming system made in accordance with the present invention is shown. In this embodiment, the system includes three separate airlaying forming chambers 44A and 44B and 44C. As described above, the use of multiple forming chambers can serve to facilitate formation of the airlaid web at a desired basis weight. Further, using multiple forming chambers can allow the formation of layered webs. As shown, forming stations 44A, 44B and 44C contribute to the formation of the airlaid web 32.

Throughout the system, the airlaid web 32 is transported on one or multiple fabrics that can be configured, for instance, in the form of endless belts. In FIG. 2, however, the fabrics are not shown in the drawing.

Airlaid web 32, after exiting the forming chambers 44A, 44B and 44C, is conveyed on a forming fabric to a compaction device 54. Compaction device 54 can be, for instance, a pair of opposing rolls that define a nip through which the airlaid web and forming fabric are passed. For example, in one embodiment, the compaction device can comprise a steel roll positioned above a rubber-coated roll. The compaction device moderately compacts the airlaid web to generate sufficient strength for transfer of the airlaid web to a transfer fabric such as, for instance, via an open gap arrangement.

More particularly, the compaction device also increases the density of the nonwoven web which is believed to improve the wipe dry characteristics of the web. For example, as described above, the density of the airlaid nonwoven web can be from about 0.05 g/cc to about 0.5 g/cc. For many embodiments, for instance, the density can be less than about 0.15 g/cc, such as from about 0.07 g/cc to about 0.10 g/cc. In general, the compaction device increases the density of the web over the entire surface area of the web as opposed to only creating localized high density areas.

After exiting the compaction device 54, the airlaid web 32 may be transferred to a transfer fabric. Once placed upon the transfer fabric, the airlaid web can be fed through an optional second compaction device and further compacted against the transfer fabric to generate desirable sheet properties, such as further improving the wipe dry characteristics of the airlaid web. The compaction device can also be used to improve the appearance of the web, to adjust the caliper of the web, and/or to increase the tensile strength of the web.

Next, the airlaid web 32 is fed to a spray chamber 56. Within the spray chamber 56, a bonding material is applied to one side of the airlaid web 32. The bonding material can be deposited on the top side of the web using, for instance, spray nozzles. Under fabric vacuum may also be used to regulate and control penetration of the bonding material into the web. The bonding material can be applied to the web in order to add dry strength, wet strength, stretchability, and tear resistance.

In general, any suitable bonding material can be applied to the airlaid web 32. Particular bonding materials that may be used in the present invention include latex compositions, such as acrylates, vinyl acetates, vinyl chlorides and methacrylates. Some water-soluble bonding materials may also be used including polyacrylamides, polyvinyl alcohols and cellulose derivatives such as carboxymethyl cellulose. In one embodiment, the bonding materials used in the process of the present invention comprise an ethylene vinyl acetate copolymer. In particular, the ethylene vinyl acetate copolymer can be cross-linked with N-methyl acrylamide groups using an acid catalyst. Suitable acid catalysts include ammonium chloride, citric acid and maleic acid.

Particular examples of bonding materials that may be used in the present invention include AIRFLEX EN1165 available from Air Products Inc. or ELITE PE BINDER available from National Starch. It is believed that both of the above bonding materials are ethylene vinyl acetate copolymers.

The present inventors have discovered that adjusting the factors that control binder surface distribution may later serve to increase the wipe dry properties of the resulting product. In this regard, controlling nozzle pressure, the solids content of the bonding material and the amount of bonding material applied to the web allows for maximization of the liquid absorption properties of the web, which translates into higher wipe dry values.

For instance, in general, lowering the spray nozzle pressure of the bonding material serves to improve the wipe dry properties of the web. For example, in various embodiments, the nozzle pressure can be less than about 100 psi, such as less than about 75 psi. In one particular embodiment, for instance, the nozzle pressure can be from about 30 psi to about 80 psi.

The present inventors have discovered that by lowering the spray nozzle pressure, larger droplets and fewer droplets of the bonding material are created and applied to the airlaid web. It is believed that the bigger and fewer droplets leave more untreated surface area on the airlaid web, which allows the web to absorb greater amounts of liquid at a faster rate.

The present inventors have also discovered that the solids content of the bonding material applied to the airlaid web may also serve to later influence the wipe dry characteristics of the web. Specifically, the water absorption characteristics of the airlaid web may be maximized by increasing the solids content of the bonding material. For instance, the solids content of the bonding material can be greater than about 10%, such as greater than about 12% or greater than about 15%. In fact, in one embodiment, the solids content can be greater than about 20%.

By increasing the solids content of the bonding material, less liquid is applied to the airlaid web. It is believed that when less liquid is present, migration of the bonding material over the surface area of the web is controlled. Similar to reducing nozzle pressure, ultimately less surface area is covered by the bonding material by increasing solids content which serves to further improve the wipe dry properties of the resultant airlaid web.

The bonding material can be applied so as to uniformly cover the entire surface area of one side of the web. For instance, the bonding material can be applied to the first side of the web so as to cover at least about 80% of the surface area of one side of the web, such as at least about 90% of the surface area of one side of the web. In other embodiments, the bonding material can cover greater than about 95% of the surface area of one side of the web.

Once the bonding material is applied to one side of the web, as shown in FIG. 2, the airlaid web 32 is then fed to a drying apparatus 58. In the drying apparatus 58, the web is subjected to heat causing the bonding material to dry and/or cure. When using an ethylene vinyl acetate copolymer bonding material, the drying apparatus can be heated to a temperature of from about 120° C. to about 170° C.

As shown in FIG. 2, from the drying apparatus 58, the airlaid web is then fed to a second spray chamber 60. In the spray chamber 60, a second bonding material is applied to the untreated side of the airlaid web. In general, the first bonding material and the second bonding material can be different bonding materials or the same bonding material. The second bonding material may be applied to the nonwoven web as described above with respect to the first bonding material.

From the second spray chamber 60, the nonwoven web is then sent through a second drying apparatus 62 for drying and/or curing the second bonding material.

As stated above, the amount of bonding material applied to the nonwoven web, in some embodiments, may influence the wipe dry properties of the web. For most applications, for instance, minimizing the amount of bonding material applied to the web may increase the wipe dry characteristics of the web. In this regard, the total add-on of the bonding material may be less than about 15% by weight of the formed product, such as less than about 13% by weight. In one particular embodiment, for instance, the total add-on of the bonding material can be less than about 8% by weight.

In one embodiment, while keeping within the above total add-on rates, a bonding material may be applied to a first side of the airlaid web in an amount that is less than the amount of bonding material applied to the second side of the airlaid web. In this embodiment, for instance, the side treated with less bonding material may have better wipe dry characteristics than the opposite side of the airlaid web. The opposite side of the airlaid web, however, may provide the web with enhanced strength characteristics.

From the second drying apparatus 62, the airlaid web 32 may optionally be fed to a further compaction device 64 prior to being wound on a reel 66. The compaction device 64 can be similar to the first compaction device and may comprise, for instance, calender rolls.

As described above, the system shown in FIG. 2 can include one or more fabrics for transporting the airlaid web 32. The fabrics can be positioned to convey the web through different stages of the process. In general, from about 1 to about 10 different fabrics can be used to convey the web from the forming chambers to the reel 66.

The airlaid web 32 may be fed to a converting line for producing the finished product. For example, in the converting line, the web can be embossed and then wound into a rolled product, such as a paper towel, an industrial wiper, and the like. For example, when embossing the web, the embossing pattern can cover from about 20% to about 60% of the surface area of the web.

In one embodiment, the airlaid web 32 may be incorporated into a single ply wiping product. Alternatively, the airlaid web can be incorporated into a multiple ply product. In a multiple ply product, an airlaid web made according to the present invention may be combined with similar airlaid webs or can be combined with other paper webs as desired. When incorporated into a multiple ply product, in some embodiments, it may only be necessary to apply the bonding material to one side of the airlaid web. The multiple plies can be bonded mechanically or chemically together.

As described above, wiping products made according to the present invention can be created that have improved wipe dry characteristics while remaining soft and flexible. The airlaid webs may have a cloth-like feel. Specifically, airlaid webs made according to the present invention can have a wipe dry of 94% or greater while yet having a geometric mean modulus of less than about 2.25 km. The wiping products can also be made at lower densities, such as less than about 0.15 g/cc.

The tensile strength of airlaid webs made according to the present invention can vary depending upon the particular application. For instance, in one embodiment, airlaid webs can be made according to the present invention having a minimum machine direction tensile strength of about 950 grams/3 inches. The minimum cross machine direction tensile strength of the airlaid webs, on the other hand, can be about 750 grams/3 inches.

It is believed that the above properties are obtained by controlling various different factors in the process of making the webs. For example, it is believed that using lower coarseness softwood fibers may contribute to the improved wipe dry properties. The manner and method of applying the bonding material may also serve to produce a product with the above properties. In particular, it is believed that nozzle pressure, solids content, and add-on of the bonding material may be controlled to optimize the liquid absorptive properties.

The present invention may be better understood with respect to the following example.

### EXAMPLE

Three different products comprising airlaid nonwoven webs made according to the present invention were formed and tested for wipe dry characteristics and geometric mean modulus. The three samples were then compared to various commercially available wet-laid and airlaid products. The above three samples were also compared to a control sample.

The first sample made according to the present invention comprised an airlaid web containing 100% by weight RAUMA BIOBRIGHT TR low coarseness Scandanavian softwood fibers. The low coarseness softwood fibers had a Pulp Coarseness Index of 13.9 mg/100 m. The airlaid web was made in accordance with the process generally shown in FIG. 2. Further, the web was embossed after being heated with a bonding material.

A bonding material was applied to both sides of the airlaid web. The bonding material used was ELITE PE obtained from National Starch and contained an ethylene vinyl acetate copolymer. The bonding material was applied at 8.5% solids at a nozzle pressure of 75 psi. The total add-on of the bonding material was 8.5%. The bonding material was sprayed on each side of the airlaid web and covered greater than 90% of the surface area of each side of the web. After being formed, the sample was tested for wipe dry and geometric mean modulus as reported below.

The second sample made according to the present invention was formed similar to the first sample. In the second sample, however, the bonding material was applied at 12% solids and the total add-on of the bonding material was 12.5%.

The third sample made according to the present invention was made from a mixture of the RAUMA BIOBRIGHT TR low coarseness softwood pulp fibers and higher coarseness fibers. The higher coarseness fibers had a pulp coarseness index of 20.0 mg/100 m. The higher coarseness fibers were CF 405 softwood kraft fibers obtained from Weyerhaeuser. The sample contained 58% by weight low coarseness softwood fibers and 42% by weight higher coarseness fibers.

The bonding material applied to the third sample made according to the present invention had a solids content of 12% and was applied at a nozzle pressure of 75 psi and a total add-on of 12.5% by weight.

A control sample was also formed containing 100% by weight of the higher coarseness fibers used in Sample No. 3. In the control sample, the bonding material was applied at 11% solids, at a nozzle pressure of 75 psi, and at a total add-on of 12.5%.

The following results were obtained from each of the above samples:

| | | | | Basis Weight |
|---|---|---|---|---|
| Sample No. | Density (g/cc) | % Wipe Dry | GMM (km) | (gsm) |
| 1 | 0.086 | 96.3 | 1.94 | 68.9 |
| 2 | 0.083 | 94.5 | 2.04 | 56.9 |
| 3 | 0.072 | 95.2 | 1.95 | 58.5 |
| Control | 0.071 | 91.1 | 2.32 | 56.3 |

Various commercially available paper wiping products were obtained and tested. The following results were obtained:

| | Fiber Furnish | Basis | | | |
|---|---|---|---|---|---|
| Product | Formation | Weight | Density | | GMM |
| Name | Method | (gsm) | (g/cc) | % Wipe Dry | (km) |
| 1^{st} Auto | Airlaid | 85.2 | 0.121 | 94.8 | 2.66 |
| Shop Towel | | | | | |
| Bolt | Airlaid | 69.6 | 0.067 | 93.2 | 1.15 |
| Bounty | Wetlaid | 40.8 | 0.063 | 95.0 | 4.05 |
| Tutto (Italy) | Airlaid | 63.1 | 0.081 | 93.6 | 3.18 |
| Scott | Wetlaid | 41.5 | 0.053 | 96.2 | 3.89 |
| ValueChoice | Airlaid | 60.5 | 0.089 | 92.3 | 2.98 |
| Viva | Wetlaid | 70.3 | 0.101 | 96.5 | 0.98 |
| Fort Soft | Airlaid | 90.3 | 0.14 | 97.0 | 4.45 |
| Maratuff | Airlaid | 71.5 | 0.094 | 94.8 | 2.5 |
| Multimaster | | | | | |
| Lotus | Airlaid | 50.5 | 0.068 | 91.5 | 3.21 |
| (France) | | | | | |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. An airlaid fibrous web comprising:
cellulosic fibers;
a bonding material applied to at least one side of the airlaid web; and
wherein the airlaid web has a wipe dry of at least about 94% in combination with a geometric mean modulus of less than about 2.25 km.

2. An airlaid web as defined in claim 1, wherein the cellulosic fibers comprise low coarseness softwood fibers.

3. An airlaid web as defined in claim 1, wherein the airlaid web consists essentially of pulp fibers.

4. An airlaid web as defined in claim 1, wherein the airlaid fibrous web consists essentially of low coarseness softwood fibers.

5. An airlaid web as defined in claim 2, wherein the low coarseness softwood fibers have a Pulp Coarseness Index of less than about 18 mg/100 m.

6. An airlaid web as defined in claim 2, wherein the low coarseness softwood fibers have a Pulp Coarseness Index of less than about 16 mg/100 m.

7. An airlaid web as defined in claim 6, wherein the low coarseness softwood fibers have a Pulp Coarseness Index of less than about 15 mg/100 m.

8. An airlaid web as defined in claim 1, wherein the airlaid web has a wipe dry of at least about 94.5%.

9. An airlaid web as defined in claim 1, wherein the airlaid web has a wipe dry of at least about 95%.

10. A airlaid web as defined in claim 1, wherein the airlaid web has a geometric mean modulus of less than about 2.10 km.

11. An airlaid web as defined in claim 1, wherein the airlaid fibrous web has a density of less than about 0.10 g/cc.

12. An airlaid web as defined in claim 1, wherein the airlaid web has a basis weight of from about 50 gsm to about 80 gsm.

13. An airlaid web as defined in claim 1, wherein the airlaid web is a one-ply product.

14. An airlaid web as defined in claim 1, wherein the bonding material is applied to each side of the airlaid fibrous web.

15. An airlaid web as defined in claim 14, wherein the bonding material covers at least 90% of the surface area of both sides of the web.

16. An airlaid web as defined in claim 14, wherein the bonding material is applied in a greater amount to one side of the airlaid web in comparison to the amount applied to an opposite side of the airlaid web.

17. An airlaid web as defined in claim 14, wherein the bonding material comprises an ethylene vinyl acetate copolymer.

18. An airlaid web as defined in claim 1, wherein the bonding material applied to the web has a solids content greater than about 12%.

19. An airlaid web as defined in claim 1, wherein the bonding material applied to the web has a solids content greater than about 15%.

20. An airlaid web as defined in claim 14, wherein the total add-on of the bonding material applied to the airlaid fibrous web is less than about 15%.

21. An airlaid web as defined in claim 14, wherein the total add-on of the bonding material applied to the airlaid fibrous web is less than about 13%.

22. An airlaid fibrous web comprising:
pulp fibers, the airlaid web having a wipe dry of at least about 94% in combination with a geometric mean modulus of less than about 2.25 km, and wherein the airlaid web has a tensile strength in the machine direction of at least 950 grams/3 inches.

23. An airlaid web as defined in claim 22, wherein the airlaid web is one-ply.

24. An airlaid web as defined in claim 22, wherein the pulp fibers comprise low coarseness softwood fibers having a Pulp Coarseness Index of less than about 18 mg/100 m.

25. An airlaid web as defined in claim 24, wherein the low coarseness softwood fibers are combined with other fibers.

26. An airlaid web as defined in claim 24, wherein the airlaid fibrous web consists essentially of low coarseness softwood fibers.

27. An airlaid web as defined in claim 22, wherein the airlaid web has a wipe dry of at least about 94.5%.

28. An airlaid web as defined in claim 22, wherein the airlaid web has a density of less than about 0.10 g/cc.

29. An airlaid web as defined in claim 22, further comprising a bonding material that is applied to both sides of the airlaid fibrous web.

30. An airlaid web as defined in claim 29, wherein the bonding material is applied in a greater amount to one side of the airlaid web in comparison to the amount applied to the opposite side of the airlaid web.

31. An airlaid web as defined in claim 29, wherein the bonding material applied to the web has a solids content greater than about 15%.

32. An airlaid web as defined in claim 29, wherein the total add-on of the bonding material applied to the airlaid fibrous web is less than about 13%.

33. An airlaid web as defined in claim 31, wherein the total add-on of the bonding material applied to the airlaid fibrous web is less than about 13%, the bonding material covering at least 90% of the surface area of each side of the web.

34. An airlaid web as defined in claim 22, wherein the airlaid web has a basis weight of from about 50 gsm to about 80 gsm.

35. A single ply wiping product comprising a spirally wound roll of a base sheet, the base sheet comprising:
an airlaid fibrous web comprising pulp fibers, the airlaid fibrous web including a first side and a second and opposite side, the pulp fibers comprising low coarseness softwood fibers;
a bonding material applied to the first side and to the second side of the airlaid fibrous web, the bonding material covering at least 90% of the surface area of each side of the web, the bonding material having a total add-on to the fibrous web of less than about 15% by weight; and
wherein the wiping product has a wipe dry of at least about 94% in combination with a geometric mean modulus of less than about 2.25 km.

36. A single ply wiping product as defined in claim 35, wherein the airlaid fibrous web consists essentially of the low coarseness softwood fibers.

37. A single ply wiping product as defined in claim 36, wherein the low coarseness softwood fibers have a Pulp Coarseness Index of less than about 16 mg/100 m.

38. A single ply wiping product as defined in claim 35, wherein the wiping product has a wipe dry of at least about 95%.

39. A single ply wiping product as defined in claim 35, wherein the wiping product has a density of less than about 0.10 g/cc.

40. A single ply wiping product as defined in claim 35, wherein the wiping product has a basis weight of from about 30 gsm to about 80 gsm.
